(19) United States
(12) Patent Application Publication
(10) Pub. No.: US 2019/0143817 A1
(43) Pub. Date: May 16, 2019

(54) OPERATION DETERMINATION DEVICE

(71) Applicant: DENSO CORPORATION, Kariya-city (JP)

(72) Inventors: Motoki TACHIIRI, Kariya-city (JP); Yoshitaka OZAKI, Kariya-city (JP)

(21) Appl. No.: 16/247,652

(22) Filed: Jan. 15, 2019

Related U.S. Application Data
(63) Continuation of application No. PCT/JP2017/020851, filed on Jun. 5, 2017.

(30) Foreign Application Priority Data
Jul. 19, 2016 (JP) 2016-141348

(51) Int. Cl. B60K 37/06; G06F 3/041; G06F 3/01

(52) U.S. Cl. CPC B60K 37/06; B60K 2350/928; G06F 3/017; G06F 3/0418

(57) ABSTRACT

An operation determination device determines a type of an operation performed on an operation unit including a distortion detection element that outputs a detection signal according to a load generated by an operation on the operation unit. The operation determination device sets, as an operation time, a period from a time when a load that is equal to or larger than an on-threshold and acquired based on a detection signal of the distortion detection element is applied, to a time when the load becomes equal to or smaller than a predetermined off-threshold, and determines the type of the operation based on at least one of a change of coordinates or a change of the load during the operation time.

### CROSS REFERENCE TO RELATED APPLICATIONS

The present application is a continuation application of International Patent Application No. PCT/JP2017/020851 filed on Jun. 5, 2017, which designated the United States and claims the benefit of priority from Japanese Patent Application No. 2016-141348 filed on Jul. 19, 2016. The entire disclosures of all of the above applications are incorporated herein by reference.

### TECHNICAL FIELD

The present disclosure relates to an operation determination device that determines types of operations.

### BACKGROUND ART

For example, a steering of a vehicle is attached with an operation device having a distortion sensor. In this case, an in-vehicle device can adopt a technology of detecting an operation on an operation unit of the operation device based on a detection signal from the distortion sensor.

### SUMMARY

The present disclosure provides an operation determination device that sets, as an operation time, a period from a time when a load that is equal to or larger than an on-threshold and acquired based on a detection signal of the distortion detection element is applied, to a time when the load becomes equal to or smaller than a predetermined off-threshold, and determines a type of an operation based on a change of coordinates and/or a change of the load during the operation time.

### BRIEF DESCRIPTION OF DRAWINGS

These and other objects, features and advantages of the present disclosure will become more apparent from the following detailed description with reference to the accompanying drawings. In the drawings,

FIG. 1 is a front view showing an installation mode of an operation device according to a first embodiment;

FIG. 2 is a system configuration diagram showing an electrical connection relationship between the operation device and a vehicle system;

FIG. 3 is a front view showing an enlarged operation surface;

FIG. 4 is a top view schematically showing the operation surface and a distortion detector;

FIG. 5 is an explanatory diagram of an operation mode of the operation surface;

FIG. 6 is a first flowchart for explaining a processing operation;

FIG. 7 is a second flowchart for explaining the processing operation;

FIG. 8 is a timing chart schematically showing changes of a load and coordinates with time during a flick operation;

FIG. 9 is a timing chart schematically showing changes of a load and coordinates with time during a tap operation;

FIG. 10 is a first flowchart for explaining a processing operation according to a second embodiment;

FIG. 11 is a second flowchart for explaining the processing operation;

FIG. 12 is a first timing chart schematically showing changes of a load and coordinates with time;

FIG. 13 is a third flowchart for explaining the processing operation;

FIG. 14 is a fourth flowchart for explaining the processing operation;

FIG. 15 is a second timing chart schematically showing changes of a load and coordinates with time;

FIG. 16 is a first flowchart for explaining a processing operation according to a third embodiment;

FIG. 17 is a second flowchart for explaining the processing operation;

FIG. 18 is a timing chart schematically showing changes of a load and coordinates with time;

FIG. 19 is a first flowchart for explaining a processing operation according to a fourth embodiment;

FIG. 20 is a second flowchart for explaining the processing operation; and

FIG. 21 is a timing chart schematically showing changes of a load and coordinates with time.

### DETAILED DESCRIPTION

In an aspect of the present disclosure, an operation determination device includes an operation time setting unit and an operation type determination unit. The operation time setting unit sets, as an operation time, a period from a time when a load that is equal to or larger than an on-threshold and acquired based on a detection signal of the distortion detection element is applied, to a time when the load becomes equal to or smaller than a predetermined off-threshold. The operation type determination unit determines a type of an operation based on a change of coordinates and/or a change of the load during the operation time. In such a configuration, the type of operation can be determined as accurately as possible.

For example, when a load applied by an operation finger or the like is detected as a small load, the position of detected coordinates may deviate from the position of coordinates originally in contact with the operation finger. In this case, the type of the operation may be erroneously determined.

In another aspect of the present disclosure, the on-threshold and the off-threshold of the load can be individually set. In this case, when it is assumed that a weak load is applied, for example, the on-threshold and the off-threshold can be set such that the position of the coordinates is equalized with the original coordinate position. Accordingly, the type of the operation can be determined as accurately as possible.

Several embodiments of an operation determination device is hereinafter described with reference to the drawings. In each of the embodiments described below, configurations and step numbers performing identical or similar actions are given identical or similar reference signs.

### First Embodiment

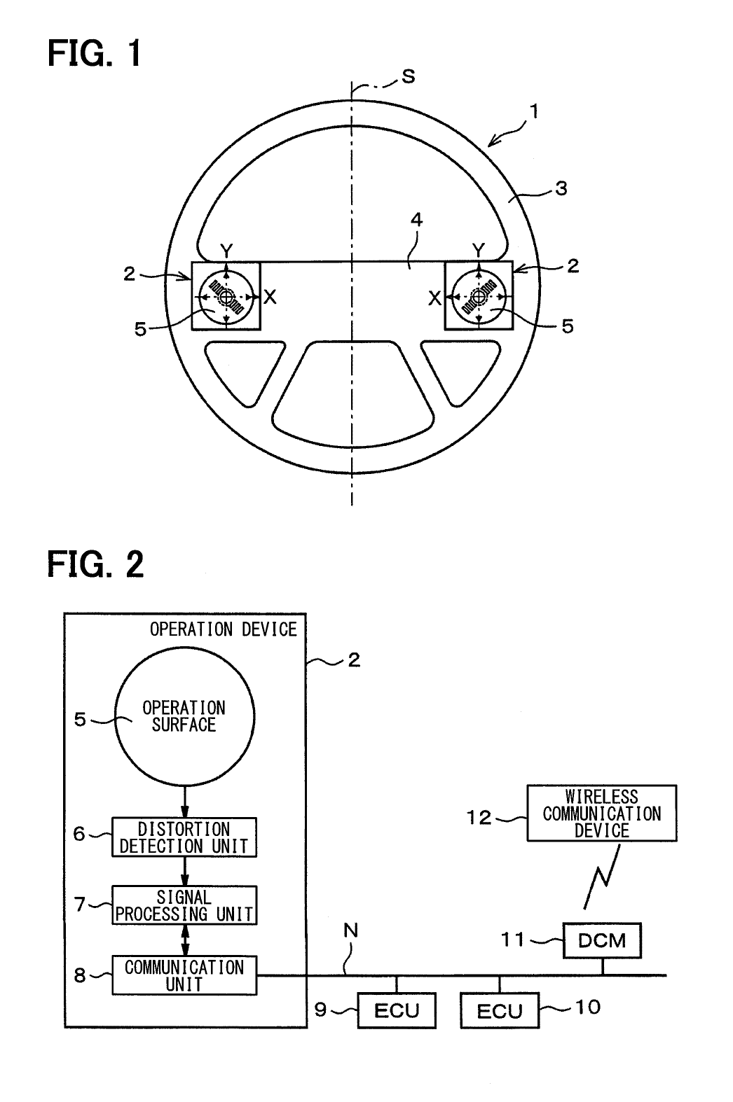

FIGS. 1 to 9 are explanatory views of a first embodiment. As shown in FIG. 1, operation devices 2 are provided on a steering 1 of a vehicle. Each of the operation devices 2 is also called as a touch pad, and attached to a spoke 4 connecting both inner end portions of a steering wheel 3. The operation devices 2 are disposed at positions bilaterally symmetrical with respect to a center line S which passes through a center of the steering wheel 3 and extending in a vehicle traveling direction (vertical direction in the figure). By grasping the steering wheel 3, a driver can naturally place operation fingers (e.g., thumbs) on the operation surfaces 5 of the operation devices 2.

Each of the operation surfaces 5 is configured to detect an operation position on X-Y coordinates whose origin is located at a center position of the operation surface 5. Each of the operation surfaces 5 is disposed such that a positive direction of an X axis coincides with an inward direction extending toward a center of the steering 1, and that a positive direction of a Y axis coincides with a traveling direction of the vehicle when a steering angle of the steering has 0 degrees (upward direction in the figure). The installation positions of the operation device 2 are not limited to the foregoing positions.

As shown in FIG. 2, each of the operation devices 2 includes: the operation surface (corresponding to operation unit) 5 having a plate shape and receiving a touch operation from the driver; a distortion detection unit 6 provided on the operation surface 5 and outputting a distortion detection signal; a signal processing unit 7 performing signal processing based on the distortion detection signal of the distortion detection unit 6; and a communication unit 8 capable of transmitting a result of the signal processing obtained by the signal processing unit 7 to external devices 9 to 12 (e.g., various types of electronic control units (ECUs) 9 and 10, data communication module (DCM) 11, and wireless communication device 12) via a network N.

For example, the signal processing unit 7 is constituted by a known microcomputer including a central processing unit (CPU), a read-only memory (ROM), a random-access memory (RAM), an analog/digital (ND) conversion circuit, and the like. Built-in ROM, RAM, and the like are hereinafter referred to as a memory. The signal processing unit 7 executes programs stored in the memory constituting a non-transitional entity storage medium. The signal processing unit 7 is thereby configured to function as an operation time setting unit and an operation type determination unit. In this case, a predetermined area of the RAM is used as a work area.

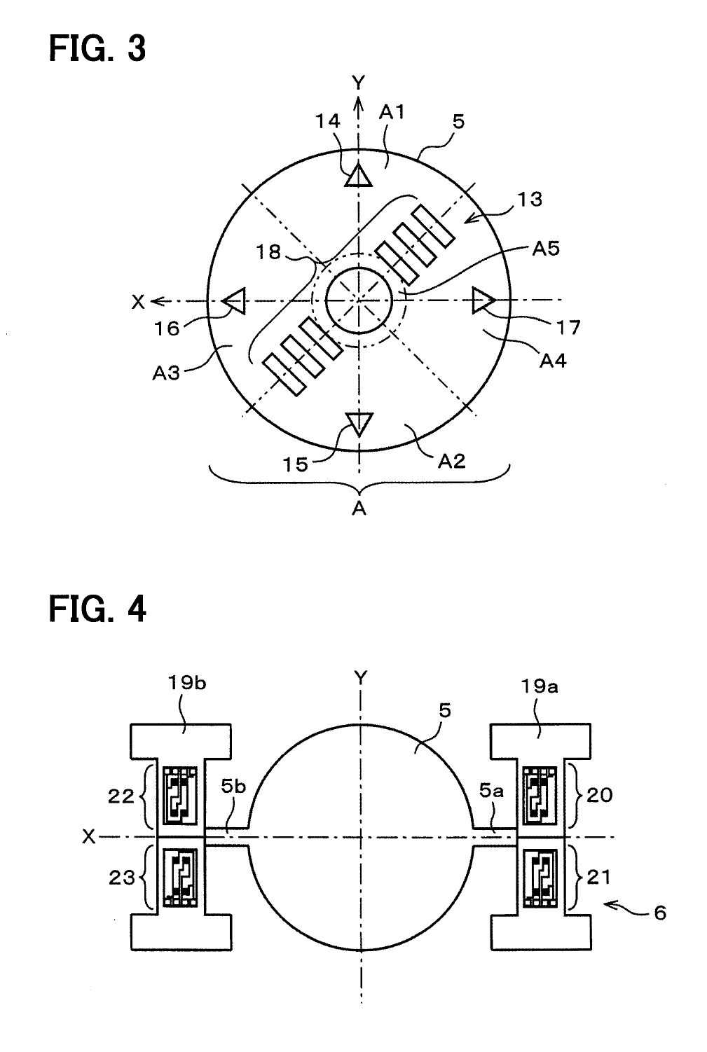

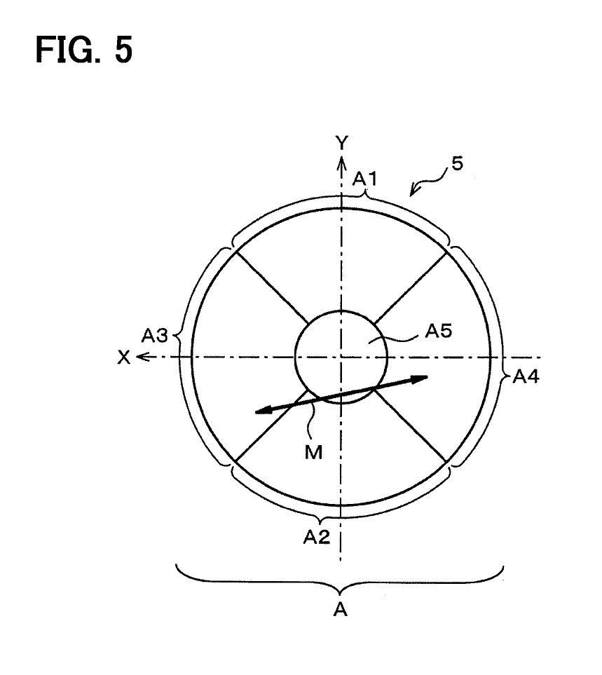

FIG. 3 is a front view of the operation surface 5 provided on the right side of the spoke 4 of the steering wheel 1 as viewed from the front. In the definition of the following description, the positive Y-axis direction corresponds to the upward direction, the negative Y-axis direction corresponds to the downward direction, the positive X-axis direction corresponds to the leftward direction, and the negative X-axis direction corresponds to the rightward direction. The operation surface 5 has a predetermined external shape such as a circular shape. The operation surface 5 may have a rectangular shape. In FIG. 3, a detection area A of the operation surface 5 is sectioned by two-dot chain lines. The detection area A is divided into an upper surface area A1, a lower surface area A2, a left surface area A3, a right surface area A4, and a central surface area A5. The operation surface 5 in FIG. 5 is similarly sectioned.

The central surface area A5 of the operation surface 5 in FIGS. 3 and 5 has a circular shape centered at a center of the X-Y axis of the operation surface 5, and having a diameter smaller than that of the external shape of the operation surface 5. The upper surface area A1 of the operation surface 5 is an area shifted in the Y-axis positive direction from the central surface area A5, indicating an area which extends from an upper circular arc of the central surface area A5 to an upper circular arc of the external shape of the operation surface 5. The lower surface area A2 of the operation surface 5 is an area shifted in the Y-axis negative direction from the central surface area A5, indicating an area extending from a lower circular arc of the central surface area A5 to a lower circular arc of the external shape of the operation surface 5.

The left surface area A3 of the operation surface 5 is an area shifted in the X-axis positive direction (left side in the figure) from the central surface area A5, indicating an area which extends from a left circular arc of the central surface area A5 to a left circular arc of the external shape of the operation surface 5. The right surface area A4 of the operation surface 5 is an area shifted in the X-axis negative direction (right side in the figure) from the central surface area A5, indicating an area which extends from a right circular arc of the central surface area A5 to a right circular arc of the external shape of the operation surface 5. In the present embodiment, respective boundary lines between the central surface area A5, the upper surface area A1, the lower surface area A2, the left surface area A3, and the right surface area A4 are not visually recognizable on the operation surface 5 in the external appearance, but may be made visually recognizable in the external appearance.

As shown in FIG. 3, the operation surface 5 includes a guide 13 which guides an operation method in the external appearance, and gives a tactile sensation to the operation finger. The guide 13 is divided into an upper guide 14 provided in an upper part, a lower guide 15 provided in a lower part, a left guide 16 provided in a left part, and a right guide 17 provided in a right part of the operation surface 5. Each of the upper, lower, left and right guides 14 to 17 has a protrusion protruding from the surface of the operation surface 5, and is so disposed as to indicate corresponding one of the upward, downward, leftward, and rightward directions by using a vertex of a triangle, for example.

The guide 13 further includes recesses 18 which guide an operation direction of a flick operation (described below). The recesses 18 are so provided as to be spaced apart from each other from the lower left to the upper right in the figure. Each rectangular shape of the recesses 18 is so provided as to have a longitudinal direction extending from the upper left to the lower right. Accordingly, in a state that the driver grips the steering wheel 3, the driver is consciously or unconsciously urged to move the thumb as the operation finger from the lower left to the upper right of the operation surface 5 as shown in FIG. 1.

The surface shape of the operation surface 5 of the operation device 2 located on the left side with respect to the center line S shown in FIG. 1 has a configuration of a structure shown in FIG. 3 subjected to bilaterally symmetrical deformation. Accordingly, the driver can recognize the operation direction of the operation finger similarly to the operation device 2 positioned on the right side with respect to the center line S, while detailed explanation of the configuration of the operation surface 5 is omitted.

FIG. 4 schematically shows a distortion detection structure of the operation surface 5 and the distortion detection unit 6. The operation surface 5 receives a pressing force in accordance with an operation by the driver. A pair of projections 5a and 5b are so provided as to project outward from a part of an outer edge of the operation surface 5. The pair of projections 5a and 5b facing each other are separated from each other in the X-axis direction with the operation surface 5 interposed between the projections 5a and 5b.

Projecting ends of the pair of projections 5a and 5b are connected to distortion generators 19a and 19b of the distortion detection unit 6, respectively. The distortion detection unit 6 includes the distortion generators 19a and 19b and distortion detection elements 20 to 23. Each of the distortion generators 19a and 19b has an I-shaped plate shape whose longitudinal direction coincides with the Y-axis direction, and is disposed in parallel with the operation surface 5. The surfaces of the distortion generators 19a and 19b are disposed in the same plane as that of the operation surface 5, and are elastically deformed to cause bending deformation in accordance with an action of a pressing force applied to the operating surface 5. The plurality of distortion detection elements 20 to 23 are disposed on the surfaces of the plurality of distortion generators 19a and 19b. The plurality of distortion detection elements 20 to 23 are respectively provided in first to fourth quadrants of the X-Y axis coordinate system, for example.

Referring to FIG. 4, the distortion detection element 20 is disposed on the upper right side of the operation surface 5, while the distortion detection element 21 is disposed on the lower right side of the operation surface 5. The distortion detection element 22 is disposed on the upper left side of the operation surface 5, while the distortion detection element 23 is disposed on the lower left side of the operation surface 5.

Each of the plurality of distortion detection elements 20 to 23 constituting the distortion detection unit 6 detects displacement of the surfaces of the distortion generators 19a and 19b as distortion, and outputs a signal corresponding to the distortion to the signal processing unit 7 as a distortion detection signal. Accordingly, the plurality of distortion detection elements 20 to 23 output different distortion detection signals depending on touch operation positions of the driver. For example, assuming that the upper right side of the operation surface 5 is touched, the distortion detection element 20 at a position close to the touch operation outputs a relatively large distortion detection signal, while the distortion detection element 23 at a position far from the touch operation outputs a relatively small distortion detection signal. An absolute amount of a distortion detection signal of each of the distortion detection elements 20 to 23 increases as a load of a touch operation becomes larger. Conversely, an absolute amount of a distortion detection signal of each of the distortion detection elements 20 to 23 decreases as a load of a touch operation becomes smaller.

Based on distortion detection signals from the distortion detection elements 20 to 23, the signal processing unit 7 is capable of calculating a load applied to the operation surface by a touch operation, and capable of calculating coordinates corresponding to the position of the touch operation on the operation surface 5. The distortion detection unit 6 cyclically acquires distortion detection signals in a cycle of 100 ms, for example, and outputs these signals to the signal processing unit 7. The signal processing unit 7 is therefore capable of acquiring operation information including load data and coordinate data in association with time, and storing the load data and the coordinate data in the memory in accordance with a time change.

As described above, the communication unit 8 is connected to the network N, for example. Various types of the ECUs 9 and 10, such as a navigation ECU, an audio ECU, and an air conditioner ECU, are connected to the network N, and the data communication module (DCM) 11 is further connected to the network N. Each of the ECU 9 and 10 is configured to include a CPU, a ROM, a RAM, an ND conversion circuit, and the like. The DCM 11 also includes a CPU, a ROM, a RAM, and further a wireless communication module to perform communication with the wireless communication device 12, such as an external smartphone, tablet, and personal computer by utilizing a wireless communication technology such as a wireless local area network (LAN) and near field wireless communication.

Each of the ECU 9 and 10 is similar to an ordinary electronic control device, and therefore is not explained in detail herein. The electrical configurations of the DCM 11 and the wireless communication device 12 such as a smartphone are similar to the electrical configurations of the ECUs 9 and 10, except that a known wireless communication module is added. Accordingly, the electrical configurations of the DCM 11 and the wireless communication device 12 are not described herein.

The communication unit 8 of the operation device 2 is configured to be communicable with the various types of the ECUs 9 and 10, and the wireless communication device 12 wirelessly connected. Accordingly, when the driver operates the operation device 2, the operation device 2 transmits the above-described operation information or related information to the ECUs 9 and 10 or the wireless communication device 12 connected to the network N in the vehicle to operate the external devices 9 to 12 based on the information.

An operation according to the characteristics of the present embodiment is described. The present embodiment is characterized by determination of types of operations performed by the operation device 2.

Initially, the types of operations are described with reference to FIG. 5. The types of operations allowed to be determined in the present embodiment include a flick operation, and a tap operation including a central surface tap and upper, lower, left, and right surface taps. For example, the flick operation is an operation performed by sliding the surface of the operation surface 5 as indicated by an arrow M using the operation finger of the driver. The tap operation is an operation performed by pressing the operation area A of the operation surface 5 by the driver (e.g., upper surface area A1, lower surface area A2, left surface area A3, right surface area A4, or central surface area A5).

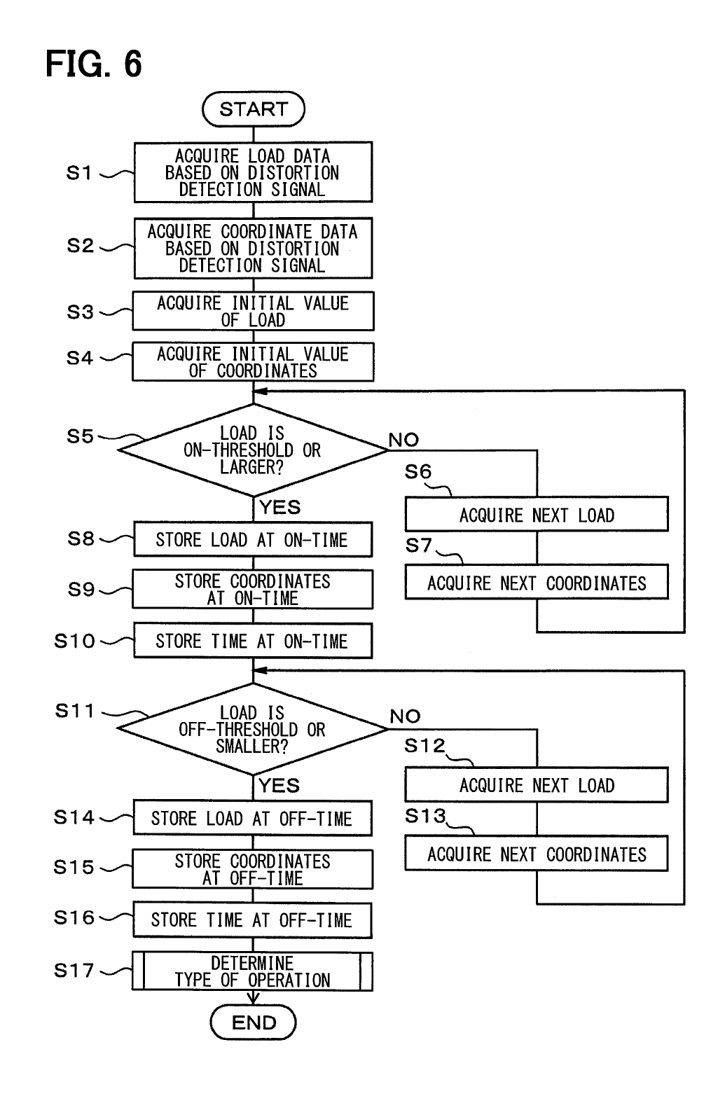

As shown in FIG. 6, the signal processing unit 7 acquires load data based on a distortion detection signal in S1, and acquires coordinate data based on the distortion detection signal in S2. These steps indicate a process of acquiring a group of data cyclically acquired. Subsequently, the signal processing unit 7 acquires initial values from the load data and coordinate data in S3.

Then, the signal processing unit 7 determines whether or not the value of the load is equal to or larger than a predetermined on-threshold in S5, and continues to acquire a load applied next in S6 until a condition that the value of the load becomes the on-threshold or larger is met. At this time, the signal processing unit 7 also acquires next coordinates in S7.

When the condition that the value of the load becomes the on-threshold value or larger is met in S5, the signal processing unit 7 stores the load applied at this on-time in the memory in S8. At this time, the signal processing unit 7 stores the coordinates at the on-time in association with time in S9 and S10.

The signal processing unit 7 further determines whether or not the value of the load is equal to or smaller than a predetermined off-threshold value in S11, and continues to acquire a load applied next in S12 until the condition that the value of the load becomes the off-threshold or smaller is met. At this time, the signal processing unit 7 also acquires next coordinates in S13. The off-threshold is preferably set higher than the on-threshold.

When the condition that the value of the load becomes the off-threshold value or smaller is met in S11, the signal processing unit 7 stores the load applied at this off-time in the memory in S14. At this time, the signal processing unit 7 stores the coordinates at the off-time in association with time in S15 and S16. Then, the signal processing unit 7 determines the type of the operation in S17.

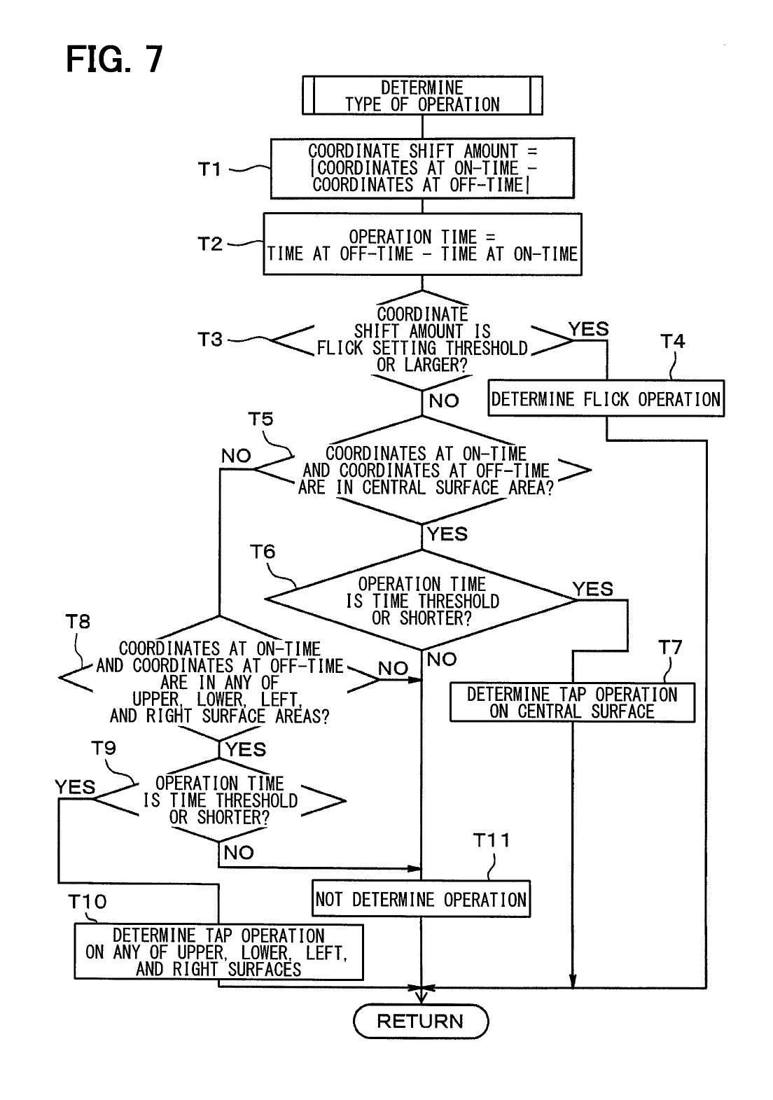

FIG. 7 shows a routine for determining types of operations. As shown in FIG. 7, the signal processing unit 7 calculates an absolute value of a difference between on-time coordinates and off-time coordinates as a distance in T1, and designates the calculated distance as a coordinate shift amount. Subsequently, the signal processing unit 7 subtracts the time at the on-time from the time at the off-time in T2 to calculate an operation time.

Under a condition that some of conditions T3, T5, T6, T8, and T9 are met, the signal processing unit 7 determines that the operation is a flick operation in T4, a tap operation at the central surface in T7, or a tap operation on one of the upper, lower, left and right surfaces in T10. When it is determined that none of these conditions is met, the signal processing unit 7 does not determine the operation in T11.

Some of these conditions are hereinafter described in detail. The signal processing unit 7 determines whether or not the coordinate shift amount is equal to or larger than a flick setting threshold in T3. This flick setting threshold indicates a threshold of a coordinate shift amount regarded as a flick operation, and is determined beforehand. Accordingly, when the coordinate shift amount is equal to or larger than the flick setting threshold, the signal processing unit 7 determines that the flick operation has been performed in T4.

In addition, the signal processing unit 7 determines whether or not the coordinates at the on-time and the coordinates at the off-time correspond to the coordinates of the central surface of the operation surface in T5. At this time, the signal processing unit 7 executes processing in T5 by determining whether or not the coordinates at the on-time and the coordinates at the off-time are located within a range of a predetermined radius from the central part of the X-Y axis. Then, the signal processing unit 7 determines that the tap operation on the central surface, that is, the tap operation in the central surface area A5 has been performed based on a condition that the operation time is equal to or shorter than a predetermined time threshold in T6. At this time, the condition of the tap operation is not determined to be met when the operation time is equal to or longer than the time threshold in T6. In this case, the operation is not determined in T11.

When determining NO in T5, the signal processing unit 7 determines in T8 whether or not the coordinates at the on-time and the coordinates at the off-time are contained in a determination area of any one of the upper, lower, left and right surfaces (i.e., upper surface area A1, lower surface area A2, left surface area A3, and right surface area A4). When determining that the respective coordinates are contained in any one of these surfaces, the signal processing unit 7 determines that the operation is a tap operation at any one of the upper, lower, left, and right surfaces A1 to A4 under a condition that the operation time is equal to or shorter than the time threshold. At this time, the signal processing unit 7 can determine which of the surfaces of the upper surface area A1, the lower surface area A2, the left surface area A3, and the right surface area A4 has been tapped based on the coordinates at the on-time and the coordinates at the off-time.

For example, in a state that the coordinates at the on-time are contained in the upper area A1, and that the coordinates at the off-time are contained in the left surface area A3, determination is NO in T8 even when the operation time is equal to or shorter than the time threshold. In this case, the operation is not determined in T11. Accordingly, erroneous determination can be reduced as much as possible.

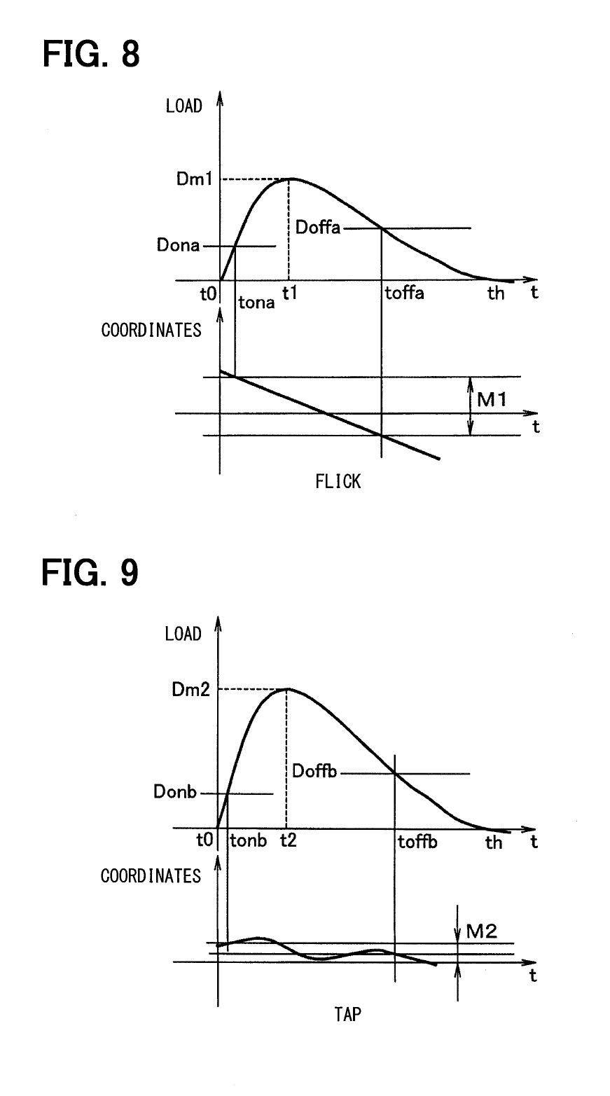

FIGS. 8 and 9 show changes of a load and coordinates with time for each type of operations. FIG. 8 shows changes of a load and coordinates with time during a flick operation, while FIG. 9 shows changes of a load and coordinates during a tap operation. Coordinate axes in FIGS. 8 and 9 are expressed one-dimensionally for simplifying the explanation. That is, it is obvious that the same is applicable to two dimensions of X-Y coordinates, wherefore description for two dimensions is not repeatedly given.

A typical example is shown in FIGS. 8 and 9. The load increases from a time t0 at which the driver taps the operation surface 5, becomes equal to or larger than on-thresholds Dona and Donb at times tona and tonb, and thereafter becomes equal to or smaller than off-threshold Doffa and Doffb at times toffa and toffb. As shown in FIG. 8, during a flick operation, the load becomes a maximum Dm1 at a time t1 between the times tona and toffa. As shown in FIG. 9, during a tap operation, a maximum Dm2 is reached at a time t2 between the times tonb and toffb.

The load reaches 0 at a time th at which the driver releases the operation finger from the operation surface 5. Accordingly, there is no particular difference in tendency between the flick operation shown in FIG. 8 and the tap operation shown in FIG. 9. On the other hand, the coordinates continuously and greatly change with an lapse of time during the flick operation in FIG. 8, but only slightly change during the tap operation in FIG. 9. In this case, a large difference is produced between coordinate shift amounts M1 and M2 for each type of operations. The coordinate shift amount M1 during the flick operation becomes larger than the coordinate shift amount M2 during the tap operation.

Accordingly, when determining that the coordinate shift amount M1 equal to or larger than the flick setting threshold is generated in T3 in FIG. 7, the signal processing unit 7 determines that the operation is a flick operation in T4. When determining that the coordinate shift amount M1 smaller than the flick setting threshold is generated, a tap operation is not determined in T7 and T10. Alternatively, operation is not determined in T11. In this manner, determination of the flick operation can be made as accurately as possible.

The concept of the characteristics of the present embodiment is summarized herein. According to the present embodiment, the signal processing unit 7 sets, as the operation time, a period from a time at which a load equal to or larger than the predetermined on-threshold and acquired based on distortion detection signals of the distortion detection elements 20 to 23 is applied, until a time at which the load becomes equal to or smaller than the predetermined off-threshold (T2 in FIG. 7), and determines types of operations based on changes of the coordinates and/or the load during the operation time (T4, T7, and T10 in FIG. 7). In this manner, types of operations can be determined as accurately as possible.

The operation surface 5 includes the guide 13 which guides the operation method in the external appearance, and gives a tactile sensation to the operation finger. Accordingly, the driver is allowed to move the operation finger along the guide 13 consciously or unconsciously.

The signal processing unit 7 determines a flick operation under a condition that the operation time is equal to or longer than the flick setting threshold. Accordingly, a flick operation can be determined as accurately as possible.

When determining NO in T6, T8, or T9 in FIG. 7, the signal processing unit 7 does not perform operation determination in T11. Accordingly, erroneous determination of operations can be reduced as much as possible.

### Second Embodiment

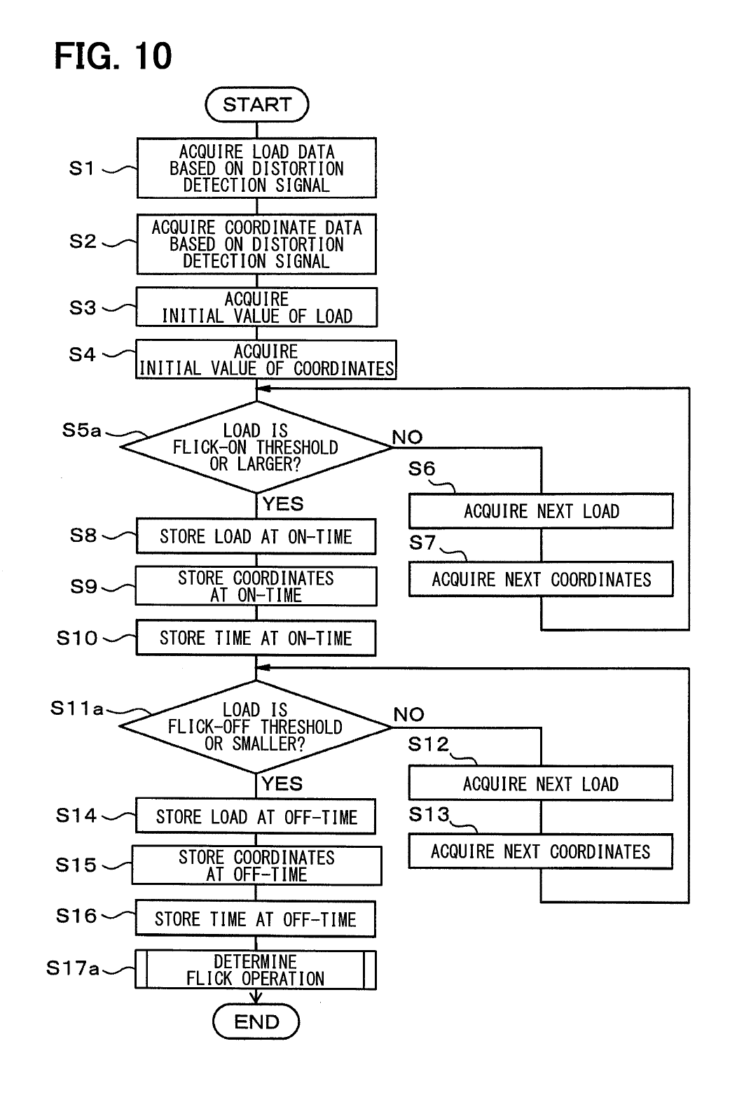

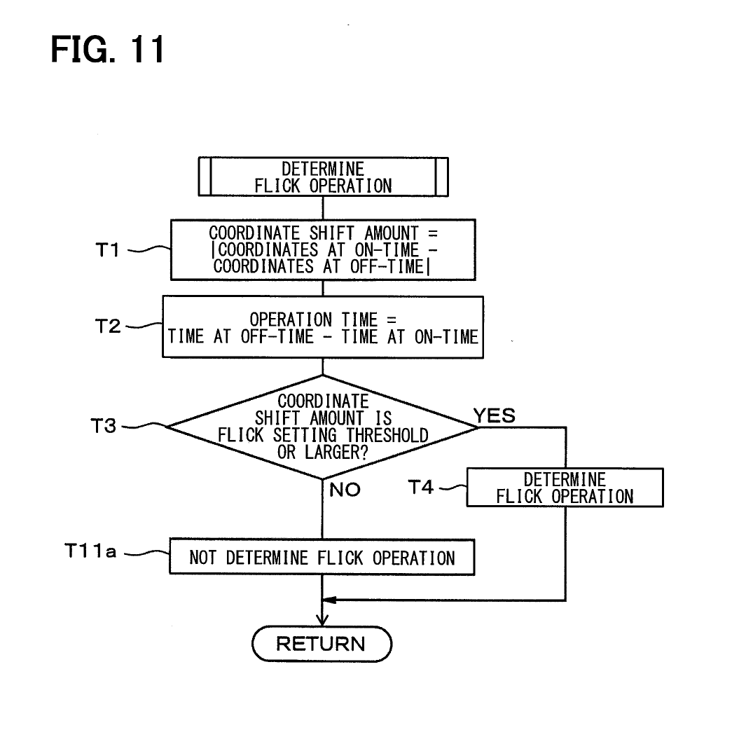

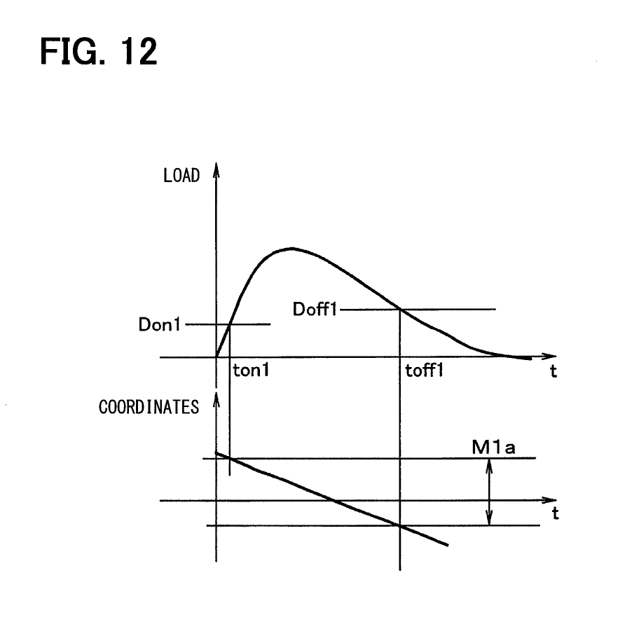

FIGS. 10 to 15 are additional explanatory diagrams of a second embodiment. A mode adopted in this embodiment is such a mode which uses independent determination thresholds for determining a flick operation and a tap operation. FIGS. 10 and 11 are flowcharts showing a process for determining a flick operation, while FIG. 12 is a timing chart indicating determination of a flick operation.

As shown in FIG. 10, the signal processing unit 7 performs determination using a flick-on threshold Don1 and a flick-off threshold Doff1 as determination thresholds in S5a and S11a, and performs a flick operation determination process in S17a. As shown in FIG. 11, the signal processing unit 7 determines a flick operation under a condition that the coordinate shift amount becomes a flick setting threshold or larger in T3. When this condition is not met, a flick operation is not determined in T11a. As shown in FIG. 12, the flick-on threshold Don1 and the flick-off threshold Doff1, which are independently set in advance, are used as determination thresholds for the on-time and off-time at the time of flick operation determination.

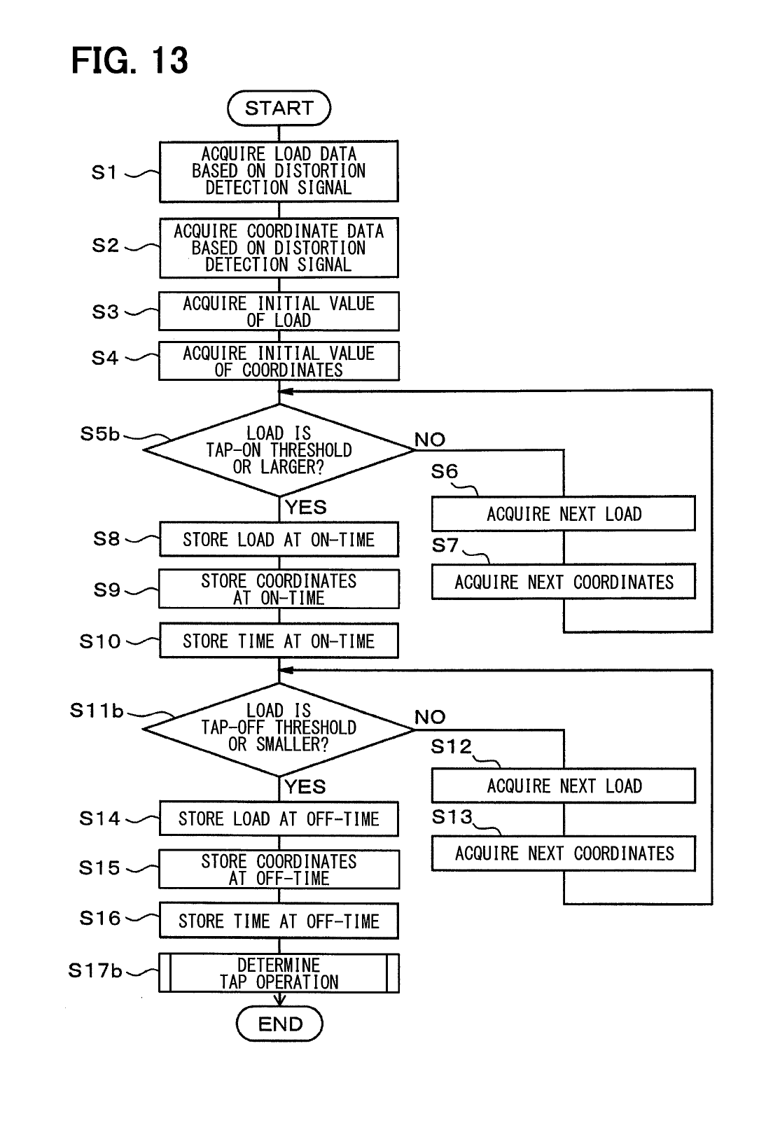

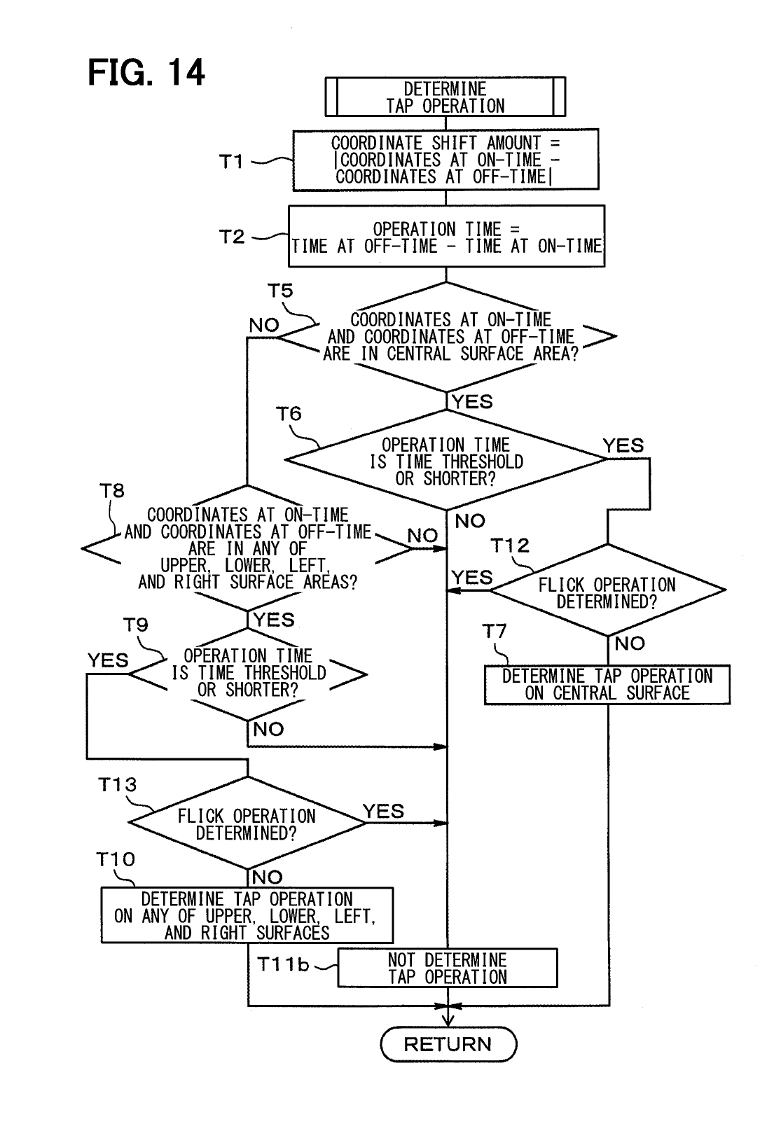

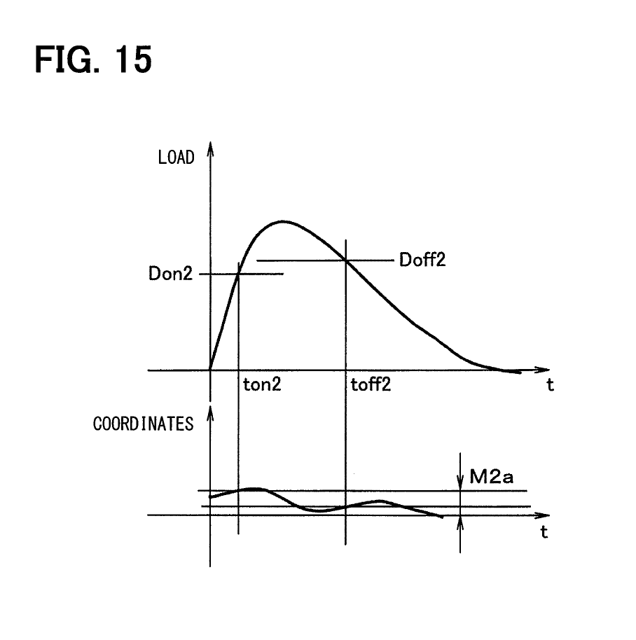

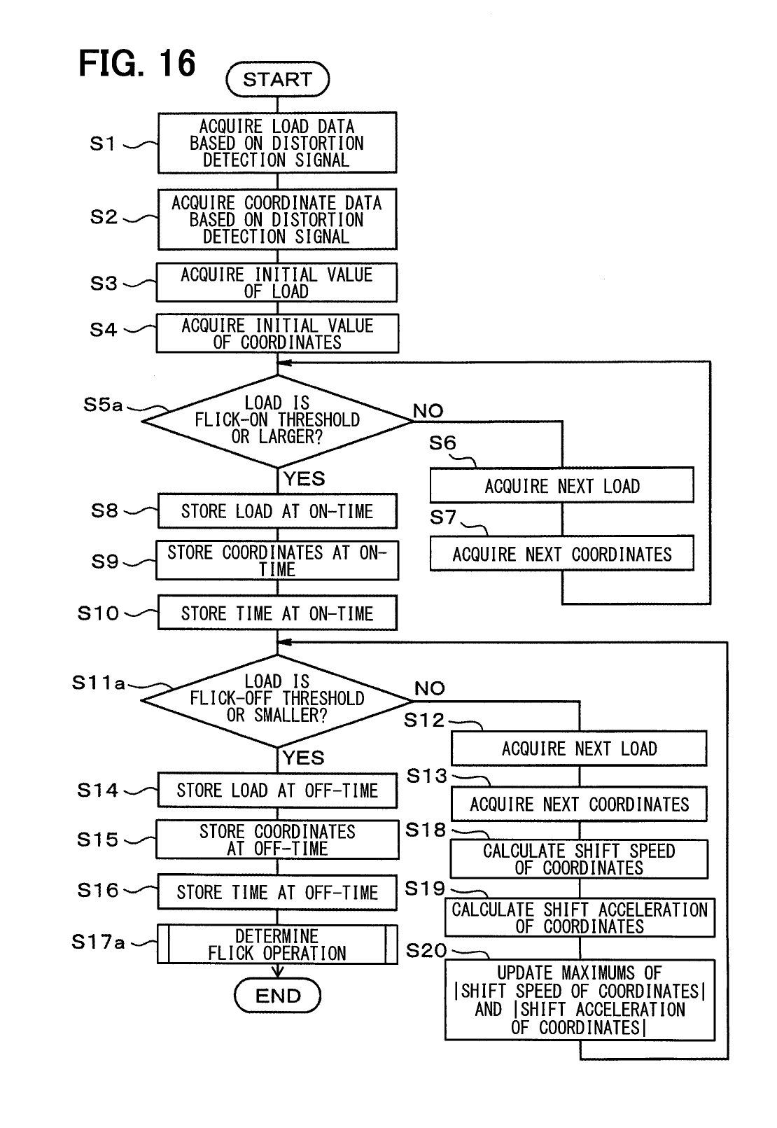

FIGS. 13 and 14 are flowcharts showing a process for determining a tap operation, while FIG. 15 is a timing chart indicating determination of a tap operation. As shown in FIG. 13, the signal processing unit 7 performs determination using a tap-on threshold Don2 and a tap-off threshold Doff2 as determination thresholds in S5b and S11b, and performs a tap operation determination process in S17b.

As shown in FIG. 14, the signal processing unit 7 determines whether or not coordinates at the on-time and coordinates at the off-time are contained in the central surface area A5 in T5. When determination is YES in T5, a tap operation on the central surface is determined in T7 under a condition that the operation time is the time threshold or shorter in T6, and that determination as a flick operation is not made in T12. In this case, processing in T12 is provided for preferentially processing the flick operation described above. When the flick operation is determined beforehand, a tap operation is not determined as shown in T11b.

When determination is NO in T5, the signal processing unit 7 determines in T8 whether or not the respective coordinates are contained in any one of the upper, lower, left, and right surface areas. When determination is YES in T8, the signal processing unit 7 determines a tap operation on any one of the upper, lower, left, and right surfaces in T10 under a condition that the operation time is the time threshold or shorter in T9, and that determination as a flick operation is not made in T13.

Similarly to the above case, processing in T13 is provided for preferentially processing the flick operation described above. When the flick operation is determined beforehand, a tap operation is not determined as shown in T11b. As shown in FIG. 15, the tap-on threshold Don2 and the tap-off threshold Doff2, which are independently set in advance, are used as determination thresholds for the on-time and off-time at the time of tap operation determination. More specifically, according to the present embodiment, the flick-on threshold Don1, the tap-on threshold Don2, the flick-off threshold Doff1, and the tap-off threshold Doff2 for setting the operation time can be individually set as shown in FIGS. 10 to 15.

A desirable relationship between the flick-on threshold Don1, the flick-off threshold Doff1, the tap-on threshold Don2, and the tap-off threshold Doff2 for a load is hereinafter described. It is assumed that the driver slides the operation finger on the operation surface 5 during a flick operation. Accordingly, a load applied to the operation surface 5 is smaller than a load applied during a tap operation.

On the other hand, it is assumed that the driver taps the operation finger on the operation surface 5 at the time of a tap operation. Accordingly, a load applied to the operation surface 5 is larger than a load applied during a flick operation. It is therefore preferable that the flick-on threshold Don1 of the load be set smaller than the tap-on threshold Don2, and that the flick-off threshold Doff1 be set smaller than the tap-off threshold Doff2.

When the load determination threshold (tap-on threshold Don2, tap-off threshold Doff2) for determining a load of a tap operation is set relatively large, a relatively small coordinate shift amount may be detected depending on a change of the load with time even in case of a sufficient shift of coordinates equivalent to or in excess of the flick determination threshold.

Accordingly, it is preferable that the flick operation determination shown in FIGS. 10 to 12 be performed in preference to the tap operation determination process shown in FIGS. 13 to 15 to initially execute the flick operation determination process. Other operations are similar to the corresponding operations in the first embodiment, and therefore are not repeatedly explained herein.

The signal processing unit 7 individually sets the on-thresholds Don1 and Don2 and the off-thresholds Doff1 and Doff2 for a load to determine the operation time for each type of operations (flick operation, tap operation) at the time of operation type determination. Accordingly, the degree of convenience improves by individual setting of necessary thresholds for each type of operations.

Moreover, in case of the flick operation, for example, a relatively small load is detected as a load applied by the operation finger. In this case, the position of the detected coordinates may deviate from the position of the coordinates originally in contact with the operation finger. Accordingly, the flick-on threshold Don1 of the flick operation is set relatively smaller than the predetermined value, and the flick-off threshold Doff1 is also set relatively smaller than the predetermined value. In this manner, the position in actual contact with the operation finger and the position of the detected coordinates can be matched as much as possible even when detection of a relatively small load is assumed at the time of the flick operation. Accordingly, types of operations can be determined as accurately as possible.

Particularly, the flick-on threshold Don1 of the flick operation is set smaller than the tap-on threshold Don2 of the tap operation, and the flick-off threshold Doff1 of the flick operation is set smaller than the tap-off threshold Doff2 of the tap operation. Accordingly, erroneous determination can be reduced as much as possible.

Moreover, the flick operation is determined in preference to the tap operation. Accordingly, erroneous determination can be reduced as much as possible.

### Third Embodiment

FIGS. 16 to 18 show additional explanatory diagrams of a third embodiment. A mode described in this embodiment is such a mode which determines an operation based on a shift speed of coordinates and/or shift acceleration of coordinates. Determination of a flick operation is particularly characteristic. Accordingly, only a part of a flick operation determination process different from the corresponding process of the second embodiment is chiefly described, and a tap operation determination process is not touched upon.

When a load reaches or exceeds the flick-on threshold Don1 in S5a, the signal processing unit 7 stores the load, coordinates, and time at the on-time in S8 to S10 as shown in FIG. 16, and acquires load and coordinate data in S12 and S13 until the load becomes equal to or smaller than the flick-off threshold in S11a.

In the present embodiment, the signal processing unit 7 calculates the shift speed of the coordinates in S18, calculates the shift acceleration of the coordinates in S19, and continues to update a maximum of an absolute value of the shift speed of the coordinates and a maximum of an absolute value of the shift acceleration of the coordinates in S20, these steps performed in a period from a time when the condition that the load becomes the flick-on threshold Don1 or larger is met in step S5a until a time when the load becomes equal to or smaller than the flick-off threshold Doff1 in S11a.

The shift speed of the coordinates in S18 can be calculated by time-differentiating the coordinates. For example, the shift speed is calculated in accordance with the coordinates and time previously calculated and the coordinates and time currently calculated. When data indicating the previous coordinates is not stored in the memory, processing in S18 may be ignored. The shift acceleration of the coordinates in S19 can be calculated by time-differentiating the shift speed of the coordinates. For example, the shift acceleration is calculated in accordance with the shift speed and time previously calculated and the shift speed and time currently calculated. When data indicating the previous shift speed is not stored in the memory, processing in S19 may be ignored.

In S20, the signal processing unit 7 sequentially updates the absolute value of the shift speed of the coordinates described above and the absolute value of the shift acceleration of the coordinates described above. The signal processing unit 7 performs a flick operation determination process in S17a under a condition that the value of the load becomes the flick-off threshold Doff1 or smaller in S11a.

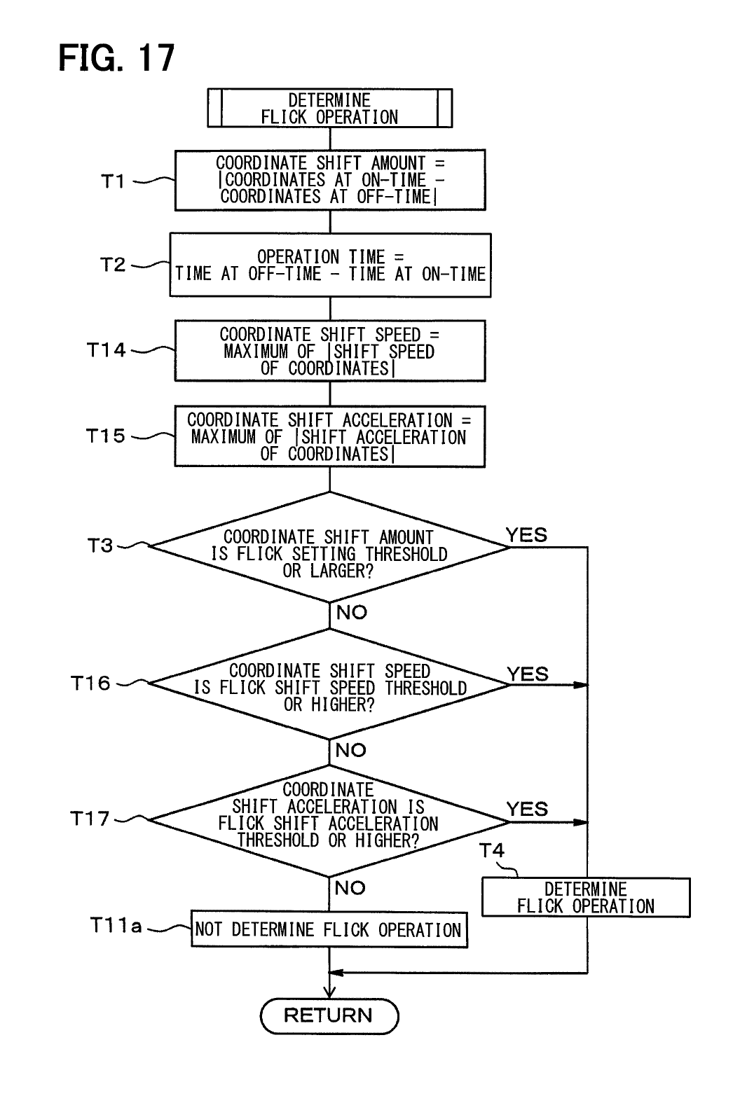

In the flick operation determination process shown in FIG. 17, the signal processing unit 7 calculates a coordinate shift amount in T1, and calculates an operation time in T2. The signal processing unit 7 further designates in T14 a “coordinate shift speed” as the maximum of the absolute value of the above-described shift speed of the coordinates acquired in S19, and designates in T15 a “coordinate shift acceleration” as the maximum of the absolute value of the above-described shift acceleration of the coordinates acquired in S20. Then, the signal processing unit 7 determines a flick operation in T4 under the condition of T3 described in the above embodiment, and further a condition that at least either a state that the coordinate shift speed is equal to or larger than a flick shift speed threshold vt in T16, or a state that the coordinate shift acceleration is equal to or larger than a flick shift acceleration threshold qt in T17 has been achieved.

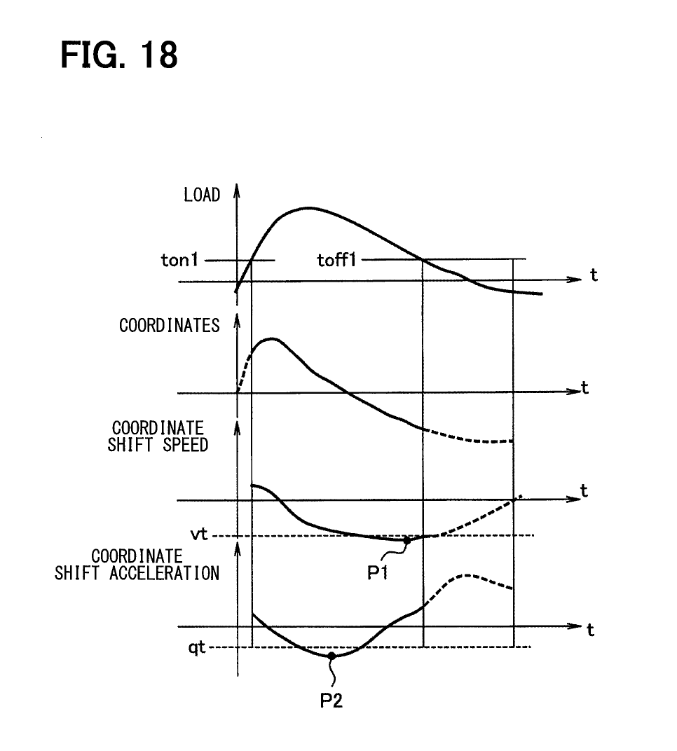

When the driver flicks the operation surface 5, the coordinate shift speed becomes higher than that of a tap operation, for example. When a maximum P1 is a maximum of the coordinate shift speed as shown in FIG. 18, a flick operation may be determined under a condition that the maximum P1 of the absolute value of the coordinate shift speed becomes equal to or larger than the predetermined flick shift speed threshold vt. When the driver flicks the operation surface 5, the coordinate acceleration becomes higher than that of a tap operation, for example. Accordingly, when a maximum P2 is a maximum of the coordinate shift acceleration as shown in FIG. 18, a flick operation may be determined under a condition that the maximum P2 of the absolute value of the coordinate shift acceleration becomes equal to or larger than the predetermined flick shift acceleration threshold qt.

While the condition that at least one of T3, T16, and T17 has been met is presented herein as the condition for determining a flick operation, the condition may be such a condition that any two or more have been met, or that all the three conditions have been met.

As described in the present embodiment, the signal processing unit 7 can reduce erroneous determination as much as possible by determining types of operations based on a speed of a change of coordinates and/or an acceleration of a change of the coordinates.

### Fourth Embodiment

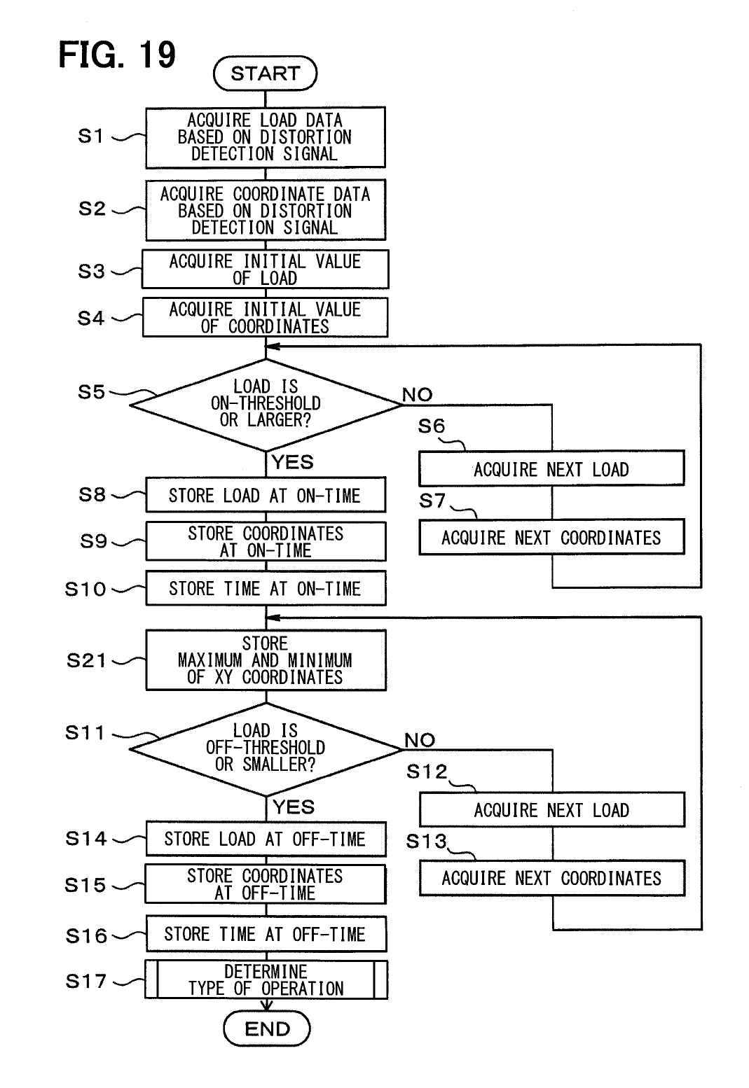

FIGS. 19 to 21 show additional explanatory diagrams of a fourth embodiment. A mode described in this embodiment is such a mode which calculates a coordinate shift amount based on a maximum and a minimum of X-Y coordinates. Parts different from the first embodiment are chiefly described, and other parts are not repeatedly described.

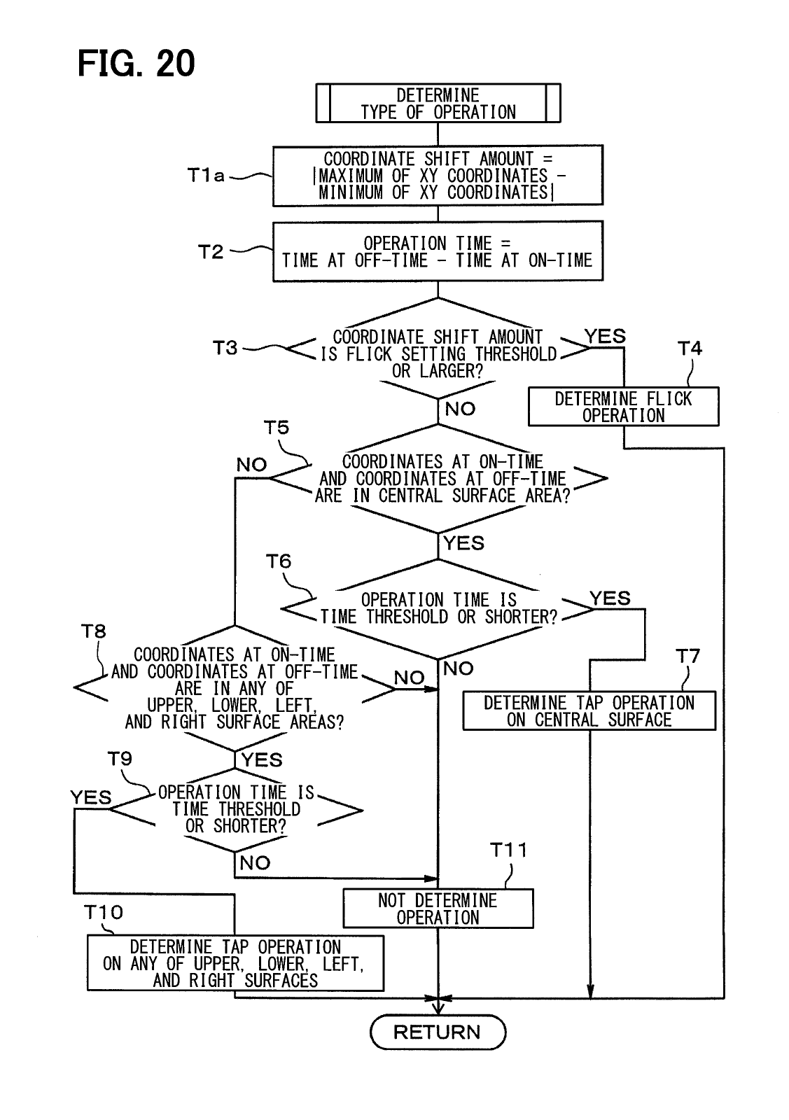

As shown in FIG. 19, the signal processing unit 7 stores a load, coordinates, and time at an on-time in S8 to S10, and then acquires maximum and minimum X and Y coordinates and stores these coordinates in the internal memory in S21 while acquiring load and coordinate data at times sequentially shifted. For example, a method of calculating the maximum and minimum of the X-Y coordinates is preferably a method which designates the maximum as a position farther from a center point (X, Y)=(0, 0) of the operation surface 5 in the X-Y positive direction, and designates the minimum as a position father from the center point in the X-Y negative direction, for example. Then, as shown in FIG. 20, the signal processing unit 7 designates the coordinate shift amount as an absolute value obtained by subtracting the minimum of the X-Y coordinates from the maximum of the X-Y coordinates in T1a, and performs processing in and after T2.

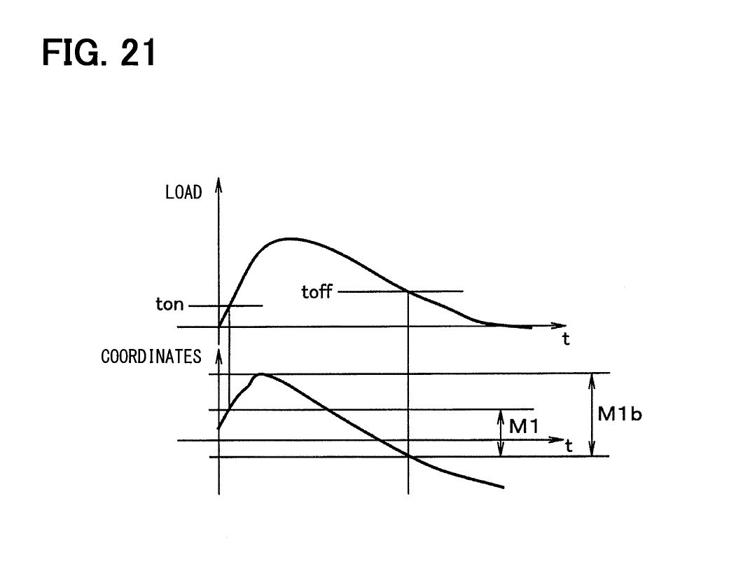

The driver may shift the operation finger in a direction different from a direction substantially equivalent to a desired direction of the shift (e.g., opposite direction) for a certain period of time from the time of contact between the operation finger and the operation surface 5. In such a case, as shown in FIG. 21, it is assumed that a large difference is produced between a coordinate shift amount M1 based on coordinates at the on-time and the off-time, and a coordinate shift amount M1b based on the maximum of X-Y coordinates and the minimum of X-Y coordinates.

The signal processing unit 7 acquires the coordinate shift amount M1b based on the difference between the maximum and the minimum. In this case, the relatively large coordinate shift amount M1b is acquired in comparison with at least the operation in the first embodiment. Accordingly, the acquired coordinate shift amount M1b becomes large even when the operation by the operation finger of the driver deviates, wherefore a flick operation can be determined as accurately as possible.

According to the present embodiment, types of operations are determined based on the coordinate shift amount M1b obtained based on the maximum and the minimum of the X-Y coordinates from the start of operation to the end of operation. Accordingly, operations can be determined as accurately as possible.

### Other Embodiments

The present invention is not limited to the embodiments described above. For example, following modifications or extensions may be made.

The operation unit in the mode described herein is the operation surface 5 having a flat shape. However, the operation unit is not limited to this mode. Various types of operation input devices including distortion detection elements may be adopted.

The operation device 2 is applied to the mode for communicating with the external devices 9 to 12. However, the operation device 2 is not limited to this mode. The operation device 2 may be mounted on the various types of ECUs 9 and 10, or may be mounted on the wireless communication device 12, for example. More specifically, the signal processing unit 7 in the mode of the above-described embodiments functions as an operation determination device. However, the operation determination device is not limited to this mode. More specifically, the external devices 9 to 12 may acquire a series of load data and coordinate data through the network N, and perform the processing of the signal processing unit 7 of the above-described embodiments. In other words, any one of the devices 9 to 12 may function as the operation determination device which determines types of operations.

The mode which includes the operation device 2 provided on the steering 1 of the vehicle has been described. However, the operation device 2 is not limited to this mode. The mode which includes the two operation devices 2 provided on the steering wheel 1 has been described. However, the one or three operation devices 2 may be provided, or the operation devices 2 may be attached to other components. The method for determining a flick operation and a tap operation has been described by way of example. However, the operations to be determined are not limited to the operations described herein. The method is applicable to various types of operations, such as a swipe operation and a slide operation, for determination of types of operations.

For example, the configurations of the above-described embodiments are only conceptual configurations. A function of one constituent element may be dispersed to a plurality of constituent elements, or functions of a plurality of constituent elements may be integrated into one constituent element. At least a part of the configurations of the above-described embodiment may be replaced with known configurations having similar functions. A part or all of the configurations of the above-described two or more embodiments may be combined, and added or substituted as necessary.

The figures show the operation surface (operation unit) 5, the signal processing unit (operation determination device, operation time setting unit, operation type determination unit) 7, the guide 13, the upper guide (guide) 14, the lower guide (guide) 15, the left guide (guide) 16, the right guide (guide) 17, the recesses (guide) 18, and the distortion detection elements 20 to 23.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An operation determination device configured to determine a type of an operation performed on an operation unit including a distortion detection element that outputs a detection signal according to a load generated by the operation on the operation unit, the operation determination device comprising:
an operation time setting unit configured to set, as an operation time, a period from a time when a load that is equal to or larger than an on-threshold and acquired based on a detection signal of the distortion detection element is applied to a time when the load becomes equal to or smaller than a predetermined off-threshold; and
an operation type determination unit configured to determine the type of the operation based on at least one of a change of coordinates or a change of the load during the operation time, wherein
the operation unit includes a guide which guides an operation method in an external appearance, and gives a tactile sensation to an operation finger, and
the guide is arranged in a direction from a lower left toward an upper right in a case of being provided on a right side of a steering wheel in a front view of the steering wheel, and in a direction from a lower right toward an upper left in a case of being provided on a left side of the steering wheel in the front view of the steering wheel.

2. The operation determination device according to claim 1, wherein
the on-threshold and the off-threshold of the load are configured to be individually set for each of types of operations.

3. The operation determination device according to claim 1, wherein
the operation type determination unit is configured to determine the type of the operation based on at least one of a speed of a change of the coordinates or an acceleration of a change of the coordinates.

4. The operation determination device according to claim 1, wherein
the operation type determination unit is configured to determine the type of the operation based on a coordinate shift amount obtained based on a maximum and a minimum of X-Y coordinates from an operation start to an operation end.

5. The operation determination device according to claim 1, wherein
the operation type determination unit is configured to determine a flick operation in preference to a tap operation as the type of the operation.

6. An operation determination device configured to determine a type of an operation performed on an operation unit including a distortion detection element that outputs a detection signal according to a load generated by the operation on the operation unit, the operation determination device comprising:
a processor configured to
set, as an operation time, a period from a time when a load that is equal to or larger than an on-threshold and acquired based on a detection signal of the distortion detection element is applied to a time when the load becomes equal to or smaller than a predetermined off-threshold; and
determine the type of the operation based on at least one of a change of coordinates or a change of the load during the operation time, wherein
the operation unit includes a guide which guides an operation method in an external appearance, and gives a tactile sensation to an operation finger, and
the guide is arranged in a direction from a lower left toward an upper right in a case of being provided on a right side of a steering wheel in a front view of the steering wheel, and in a direction from a lower right toward an upper left in a case of being provided on a left side of the steering wheel in the front view of the steering wheel.
